(19) United States
(12) Patent Application Publication
(10) Pub. No.: US 2003/0207094 A1
(43) Pub. Date: Nov. 6, 2003

(54) Resistivity-controlled image recording sheet

(75) Inventors: Joseph C. Carls, Austin, TX (US); Dennis D. Anderson, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/135,142

(22) Filed: Apr. 30, 2002

(51) Int. Cl. B32B 3/00

(52) U.S. Cl. 428/211.1; 428/500; 428/195.1

(57) ABSTRACT

An image recording sheet comprising a substrate having a first surface opposite a second surface. A toner receptor layer coated on at least the first surface of the substrate includes a binder having a concentration from about 19 dry wt % to about 80 dry wt % of the receptor layer. The binder holds a conductive polymer and a filler having a concentration from about 19 dry wt % to about 80 dry wt % of the receptor layer. The filler interacts with the conductive polymer to provide an antistat imparting to the toner receptor layer a surface resistivity in a range from 10¹¹ ohms/square to 10¹³ ohms/square. The image recording sheet uses conducting polymers selected from polyanilines and polythiophenes in a concentration from about 0.5 dry wt % to about 3.0 dry wt % of the receptor layer. Suitable fillers have an average particle size from about 5 nm to about 100 nm.

### BACKGROUND OF THE INVENTION

1. Field of the Invention

The invention relates to resistivity-controlled static charge dissipative compositions and more particularly to toner image recording sheets for copying machines and printers using electrophotographic technology. Control of the surface resistivity of an image receptor layer, in a narrow range of about 10¹¹ Ω/square to about 10¹³ Ω/square, promotes toner transfer from a photoimaging intermediate to an image recording sheet to provide quality images measured in terms of image resolution and color saturation. The present invention also provides highly transparent image recording sheets for overhead projector applications.

2. Description of the Related Art

Since the introduction of electrophotographic copying and printing machines, using toner powder particles to develop electrostatic charge patterns, there has been a continuing emphasis on toner image transfer with faithful, quality fused image reproduction on the surface of a receptor sheet. From the early development of imaging systems using black toner powder transferred to plain paper, electrophotographic imaging technology now extends to deposition of colored images on paper and clear film. Images applied to clear film produce colored image transparencies suitable for projection using overhead projectors. With each development in technology, a need has arisen to re-visit issues of image quality with recent emphasis on transparency, color saturation, image contrast, edge sharpness, toner fusion and other characteristics that could reduce the acuity and visual impact of a projected image.

Formation of a color image requires sequential transfer of color-separated layers of at least three toners, including yellow, magenta and cyan colored toners. Additional image contrast results when the color-separated layers include a black toner for full-color imaging. The electrical condition of the surface of an image receptor layer has a significant influence during the transfer of each layer of colored toner from the photoreceptor to an image recording sheet. Image toner transfer occurs under the influence of an electrical field gradient that requires some regulation to enhance the quality of the final color image. Electrically conducting materials have proven useful for regulating surface resistivity when applied to one or both sides of toner receptor sheets.

A variety of known conductive agents have been included in surface coatings for paper sheets and film transparencies suitable for imaging using electrophotographic color copiers and printers. A number of references describe particular types of conductive materials that assist in the dissipation of electrostatic charge. For example, Japanese Patent (laid open) No. 81539/1973 describes the use of quaternary ammonium salts to control surface resistivity within a desired range. This type of material controls surface resistivity by an ionic mechanism that is sensitive to changes in humidity. Certain humidity conditions have an adverse effect upon image quality. Other coating formulations, such as those described in Japanese Patent (laid open) No. 238576/1987, exhibit changes in image quality based upon variation in both humidity and temperature.

U.S. Pat. No. 6,063,538 recommends materials that operate by an electronic mechanism as being more effective in controlling electrical properties of materials without the problems of environmental factors such as temperature and humidity. Further description reveals the preparation of an image receiving sheet that has good affinity for toner powder. The image receiving sheet comprises a substrate and a receptive layer of a thermoplastic resin and a non-ionic conductive material including a metal oxide or a conductive polymer material. A suitable toner powder receptive layer has a surface electric resistivity of 10⁸ Ω/square to 10 ¹³ Ω/square as measured between temperatures of 10° C. to 30° C. and relative humidities (RH) of 30% to 80%.

Although successful in avoiding problems of environmentally produced variable image quality, metal oxide and conductive polymer-containing image receiving sheets having surface resistivities below about 10¹¹ Ω/square, are not free from image defects. These defects occur because low surface resistive material allows leakage of charge away from the surface of an image receiving sheet. Charge leakage interferes with the electrical field gradient by which charged toner particles migrate from a photoreceptor surface to the surface of a toner image receiving sheet. If toner particles are not drawn sufficiently towards the image receiving sheet the images captured thereon have a washed-out appearance. Also there is no confirming evidence that conductive polymers provide toner powder receptive layers having consistent surface resistivity characteristics. A need exists for toner powder receptor layers having controlled electrical surface characteristics that not only overcome problems associated with environmental conditions but respond to the application of an electric field by providing consistent electric field gradients. Consistent electric field gradients promote effective migration of toner images from the photoreceptor of an electrophotographic unit to the surfaces of image receiving sheets to provide images of consistent quality.

### SUMMARY OF THE INVENTION

The present invention provides image recording sheets having consistently reproducible surface resistivity to satisfy the need for toner powder images of consistent quality. A distinguishing feature of the present invention is the use of dry powder antistats comprising powders treated with conductive polymers. Progressive addition of amounts of filler and optimization of the concentration of conductive polymer at each level of filler led to coating compositions that, upon drying, had consistent values of surface resistivity in a range, of about 10¹¹ Ω/square to about 10¹³ Ω/square. Surface resistivities in this range are associated with quality reproduction of images by color electrophotographic processes.

A toner image recording sheet according to the present invention may be formed by applying a fluid coating comprising a binder, a powdered antistat and various additives. Interaction of a powder of colloidal dimensions with a conductive polymer produces the required powdered antistat. Compositions according to the present invention may be prepared as aqueous dispersions that may be applied to transparent or opaque substrates using conventional coating methods.

Solid antistats providing surface resistivities in a range from about 10¹¹ Ω/square to about 10¹³ Ω/square according to the present invention include powdered materials treated with a conductive polymer. Preferred powdered materials include colloidal silica, and organic filler particles of colloidal dimensions. Treated powder antistats have an average particle size in the range from <5 nm to about 100 nm preferably from about 5 nm to about 80 nm. Filler content is preferably in the range from about 19% to about 80% by weight based on the total composition for the toner image receptor layer.

More particularly, the present invention provides an image recording sheet comprising a substrate having a first surface opposite a second surface. A toner receptor layer coated on at least the first surface of the substrate includes a binder having a concentration from about 19 dry wt % to about 80 dry wt % of the receptor layer. The binder holds a conductive polymer and a filler having a concentration from about 19 dry wt % to about 80 dry wt % of the receptor layer. The filler interacts with the conductive polymer to provide an antistat imparting to the toner receptor layer a surface resistivity in a range from 10¹¹ ohms/square to 10¹³ ohms/square. The image recording sheet uses conducting polymers selected from polyanilines and polythiophenes in a concentration from about 0.5 dry wt % to about 3.0 dry wt % of the receptor layer. Suitable fillers have an average particle size from about 5 nm to about 100 nm.

The present invention further provides a toner powder receptor comprising a binder having a concentration from about 19 dry wt % to about 80 dry wt % of the receptor layer. The binder holds a conductive polymer and a filler having a concentration from about 19 dry wt % to about 80 dry wt % of the receptor layer. The filler interacts with the conductive polymer to provide an antistat imparting to the toner powder receptor a surface resistivity in a range from 10¹¹ ohms/square to 10¹³ ohms/square.

An antistat according to the present invention comprises the product of interaction of an electronically conducting polymer with a filler having a particle size from about 5 nm (0.005 μm) to about 100 nm (0.1 μm).

As used herein, these terms have the following meanings.

1. The term “antistat” or “antistatic agent” or “solid antistat” or “powdered antistat” and the like refer to dry compositions including a filler and conducting polymer. An antistat according to the present invention has a surface resistivity in the range from about 10¹¹ ohms/square to about 10¹³ ohms/square

2. The term “image receptor layer” or “toner receptor” or “receptor layer” and the like refer to dried coatings containing a binder and an antistat according to the present invention.

3. An “image recording sheet” includes a substrate having an image receptor layer on at least one surface thereof. Electrophotographic copiers and printers use image recording sheets to capture toner powder images transferred from photoreceptor surfaces.

4. The term “compatibilizer” means a material included in a coated receptor layer to reduce light scattering from images formed by fusing color toner powder patterns at the surface of the receptor layer.

Concentrations of materials included in dried coatings are expressed herein in terms of wt %.

### DETAILED DESCRIPTION OF THE PREFERRED EMBODIMENT

It is customary to include an antistatic agent in a surface layer or receptor layer of an image recording sheet used to capture toner powder images. Antistatic agents moderate the formation and retention of charged species in a receptor layer so that it acquires a surface resistivity for good toner powder transfer and high fidelity image reproduction. Transfer of toner powder from one surface to another under the influence of an electrical field gradient is an important step in electrophotographic imaging processes associated with modern, computer-controlled copiers and printers. One requirement of electrophotographic imaging processes is the need to control the surface resistivity of receptor layers within a selected range. This requirement is important using copying and printing equipment that has only single color, usually black, imaging capability. The complexity of multi-color electrophotography makes this requirement even more important. For example, in color copiers and laser printers there is a sequencing of toner transfer steps as multiple layers of color-separated toner images migrate, under the influence of an electrical field gradient, from a photoreceptor surface, where the image forms, to an image receptor to which the image is fixed by high temperature fusion of the toner powder. The transfer process requires a balance of surface resistivities that allows transfer of subsequent layers of colored toner without disturbing powder previously transferred.

It has already been mentioned that conductive materials previously applied to paper, or transparency film surfaces exerted control of static charge using ionic materials having susceptibility to humidity. As humidity varied, the electric surface resistivity of ionically modified surfaces varied over many orders of magnitude. Imaging defects occurred during exposure of electrophotographic image reproduction equipment to humidity variation over a relatively wide range. Toner image quality suffers at low humidities where electric surface resistivities are typically high, as well as at high humidities where surface resistivities are low. Image problems may be different at extremes of humidity but, nevertheless, will cause loss of image quality.

Recognition of humidity sensitivity of ionic materials led to the search for charge dissipative materials or compositions, which were substantially insensitive to changes in humidity. The use of substantially humidity insensitive antistats was expected to improve the image quality associated with electrophotographic imaging equipment.

As an alternative to the use of ionic antistats, United States Patent U.S. Pat. No. 6,063,538 suggests the use of conductive materials that conduct electricity by an electronic mechanism. This reference uses an image receiving sheet comprising a substrate having a receptive layer on at least one side. The receptive layer comprises a thermoplastic resin and an electronically conductive material. Image receiving sheets of this type have electrostatic charge-dissipating properties and surface electric resistivities substantially immune to temperature and humidity fluctuation. A preferred electronically conducting material comprises a metal oxide or a conductive polymer material. The metal oxide preferably comprises tin oxide doped with antimony. Preferably, the tin oxide has a fiber length of 0.1 to 2 micron and comprises an acicular crystal having an aspect ratio of 10 to 50. Preferred conductive polymer materials have a π-electron conjugate structure. Specific examples of conductive polymer materials include sulfonated polyaniline, and polythiophene.

The reference (U.S. Pat. No. 6,063,538) recognizes that the surface electric resistivity of image receiving sheets is affected by concentrations of the electronically conducting material in the thermoplastic resin and the thickness in the receptive layer, which preferably is 0.5 μm. Both concentration and thickness affect the surface electric resistivity that needs to be maintained within one order of magnitude of a range from 10⁸ Ω/square to 10¹³ Ω/square as measured between temperatures of 10° C. to 30° C. and relative humidities of 30% to 80%.

Antistats according to the present invention were developed to overcome problems of image quality that persist even using electronically conducting polymers previously discussed. Electronically conducting polymers not only exhibit insensitivity to changes in temperature and humidity but may also possess other characteristics of colorlessness and transparency that are valuable in imaging applications. Suitable electronically conducting polymers include sulfonated polyaniline, chemically doped polyacetylene, polyparaphenylene vinylene, polyparaphenylene sulfide, chemically polymerized and doped polypyrrole, polythiophene, polyaniline, heat treated polyamide and heat treated perylenic anhydride, with polythiophene and related materials being preferred. BAYTRON P is a product containing polythiophene that has properties desirable for the preparation of antistatic agents according to the present invention. This polymeric material is transparent and may be added at low concentration to coating compositions that, applied to suitable substrates, produce image receptor layers having relatively low surface resistivities.

Following the description of U.S. Pat. No. 6,063,538 it was surprising to discover that coatings of BAYTRON P in a suitable resin did not behave as suggested. Careful review of the reference revealed that addition of sulfonated polyaniline (Ref. Example 4) produced receptor layers having the lowest values of surface electric resistivity (3×10⁹ Ω/square to 5.5×10⁹ Ω/square). These receptor layers also showed “slight failure” in toner transfer (see Table 1). Surface electric resistivity measurements were not included for BAYTRON P (Ref. Example 8).

Due to the difficulties of achieving expected results, it was concluded that either the suggested range of 10⁸ Ω/square to 10¹³ Ω/square was incorrect or electronically conducting polymers were not reliable for producing image receptor layers having surface electric resistivities in the suggested range. Further study, using BAYTRON P as the conductive polymer, led to erratic results. Attempts to optimize resin coating formulations, containing BAYTRON P, were unsuccessful for providing image receptor layers having surface resistivities within the target range. Receptor layers containing a resin binder and conductive polymer were so unstable that duplicate formulations mixed multiple times showed a lot to lot variation in surface resistivity over a range of several orders of magnitude. Surface resistivity measurement on test samples mostly gave values outside a range of about 10¹¹ Ω/square to about 10¹³ Ω/square, which, according to the present invention, gives optimum image quality. When the surface resistivity of the receptive layer is lower than about 10¹¹ Ω/square incomplete transfer of toner powder occurs. This causes a noticeable loss in image density and color saturation. A receptor surface having a surface resistivity exceeding 10¹³ Ω/square becomes susceptible to charge retention. This leads to the unfavorable occurrence of discharge events that may occur with paper separation after transfer of toner powder or repulsion and ejection of toner powder during transfer from the photoreceptor surface to an image recording sheet. Discharge events of this type cause image distortion and resultant deterioration of image quality.

Experimentation to optimize the surface resistivity of toner image recording sheets was only occasionally successful for examples of the type described in U.S. Pat. No. 6,063,538. In this reference, image receiving sheets include a dry layer containing primarily a resin and an electronically conductive metal oxide or conductive polymer. No evidence exists to show the effect of other additives except for the property of “carriability” attributed to the addition of relatively large particle size fillers. The meaning of this term remains unclear since it is not described by definition or experiment. It appears to relate to ease of sheet handling, perhaps for sheet transport through electrophotographic equipment during imaging.

Earlier designation of a range of surface resistivities from 10⁸/square to 10¹³ Ω/square apparently overlooked the aspect of electrostatic charge theory that designates materials having a resistance of 10⁵ Ω to 10¹³ Ω as static dissipative. Static dissipative materials having surface resistivities below about 10¹¹ Ω/square allow charge to leak away from surfaces at rates that cause loss of the electrical field gradient required, in electrophotography, for toner powder transfer to an image recording sheet. Loss of electrical field gradient reduces attractive forces needed for charged toner powder migration. This leads to poor image transfer, loss of image density and poor color saturation.

Surface resistivities above about 10¹¹ Ω/square allow surface charge retention at levels conducive with formation of electric field gradients that draw charged toner particles towards surfaces having the opposite electrical charge. Successful electrophotographic imaging relies upon surface resisitivities in the upper dissipative range of 10⁹ Ω/square to 10¹⁴ Ω/square and preferably 10¹¹ Ω/square to 10¹³ Ω/square.

The search for image recording sheets having consistently reproducible surface resistivity led to dry powder antistats according to the present invention. Progressive addition of amounts of filler and optimization of the concentration of conductive polymer at each level of filler led to coating compositions that, upon drying, had consistent values of surface resistivity in the target range, of about 10¹¹ Ω/square to about 10¹³ Ω/square, required for color electrophotography.

Coating compositions according to the present invention comprise a solid antistat dispersed in a suitable fluid binder. The antistat appears to form during interaction of a powder of colloidal dimensions with a conductive polymer. Compositions according to the present invention may be prepared as aqueous dispersions.

Solid antistats providing surface resistivities in a range from about 10¹¹ Ω/square to about 10¹³ Ω/square according to the present invention include powdered materials treated with a conductive polymer. Suitable powdered materials include any one or both of a polymeric filler and an inorganic filler. Useful polymeric fillers include, but are not limited to, acrylic particles, e.g., polybutylmethacrylate, polymethylmethacrylates, hydroxyethylmethacrylate, and mixtures or copolymers thereof, polystyrene, polyethylene, and the like. Inorganic fillers usable herein include any filler of colloidal dimensions, preferably including colloidal silica, alumina, and suitable clays. Powders used for antistats according to the present invention have an average particle size preferably in the range from <5 nm to about 100 nm. Filler content is preferably in the range from about 20% to about 80% by weight based on the binder for the toner image receptor layer.

Image recording sheets according to the present invention have an image receptor layer that includes a binder, powdered antistat, and optionally compatibilizers and lubricant additives applied to at least one side of a substrate to receive and retain high quality toner powder images.

Film substrates may be formed from any polymer capable of forming a self-supporting sheet, e.g., films of cellulose esters such as cellulose triacetate or diacetate; polystyrene; polyamides; vinyl chloride polymers and copolymers; polyolefin and polyallomer polymers and copolymers; polysulphones; polycarbonates; polyesters; and blends thereof. Suitable films may be produced from polyesters obtained by condensing one or more dicarboxylic acids or their lower alkyl diesters in which the alkyl group contains up to 6 carbon atoms, e.g., terephthalic acid, isophthalic, phthalic, 2,5-,2,6-, and 2,7-naphthalene dicarboxylic acid, succinic acid, sebacic acid, adipic acid, azelaic acid, with one or more glycols such as ethylene glycol; 1,3-propanediol; 1,4-butanediol; and the like.

Preferred film substrates or backings for use with projection transparencies are cellulose triacetate or cellulose diacetate; poly(ethylene naphthalate); polyesters; especially poly(ethylene terephthalate), and polystyrene films. Poly(ethylene terephthalate) is highly preferred. Preferred film substrates have a caliper ranging from about 50 μm to about 200 μm. Film backings having a caliper of less than about 50 μm are difficult to handle using conventional methods for graphic materials. Film backings having calipers over about 200 μm are stiffer, and present feeding difficulties in certain commercially available electrographic printers.

When polyester film substrates are used, they can be biaxially oriented to impart molecular orientation, and may also be heat set for dimensional stability during fusion of the image to the support. These films may be produced by any conventional extrusion method.

Where recorded images are viewed by reflected light, the resin sheet or film is preferably an opaque sheet or film, such as a white sheet or film, with a colorant or the like added thereto. In this case, examples of the substrate include papers, such as plain papers and coated papers, plastic films, and plastic-based synthetic papers.

Binders, used either in solution or dispersion, include polymeric binders which, after coating and drying, have the capability to produce coated layers of high clarity and excellent scatter-free light transmission.

Useful binders include thermoplastic resins such as polyester resins, styrene resins, acrylic resins, epoxy resins, styrene-butadiene copolymers, polyurethane resins, vinyl chloride resins, styrene-acrylic copolymers, and vinyl chloride-vinyl acetate resins.

One preferred binder class is polyester resins, including sulfopolyester resins, e.g., Eastek 1200, a sulfopolyester resin available from Eastman Chemical, and “WB-50”, a sulfopolyester resin made by 3M Company.

Another preferred binder class is polyurethanes. Useful commercially available polyurethanes are usually provided as a dispersion which may include one or more polyurethane structure. Some useful commercial resins include, from Zeneka Resins, NeoRez R-966, an aliphatic-polyether polyurethane; NeoRez® XR-9699, aliphatic-polyester acrylate polymer/polyurethane (65/35 wt %) hybrid; from Dainichiseika Co. Ltd., Resamine® D-6075 an aliphatic-polycarbonate polyurethane, Resamine® D-6080 aliphatic-polycarbonate polyurethane, and Resamine® D-6203 aliphatic-polycarbonate polyurethane; from Dainippon Ink and Chemicals, Inc., Hydran AP-40F an aliphatic-polyester; Hydran ®AP-40N, an aliphatic-polyester polyurethane, and Hydran® HW-170, an aliphatic-polyester. Especially preferred polyurethane dispersions are available from B. F. Goodrich Co. under the trade name Sancure®, e.g., Sancure (777, Sancure® 843, Sancure® 898, and Sancure® 899, all of which are aliphatic polyester polyurethane dispersions and SANCURE 2710 and SANCURE 2715, which are aliphatic polyethers.

The binder material holds the solid antistat comprising powders, previously described, treated with a conductive polymer. Suitable conductive polymers include materials having a π-electron conjugate structure such as sulfonated polyaniline, chemically doped polyacetylene, polyparaphenylene vinylene, polyparaphenylene sulfide, chemically polymerized and doped polypyrrole, polythiophene, polyaniline, heat treated product of polyamide and heat treated product of perylenic anhydride. Receptor layers of controlled surface resistivity according to the present invention preferably use a commercial polythiophene product available from Bayer Akt. of ? as BAYTRON P.

Formulations and coatings of the invention optionally comprise a compatibilizer. Useful compatibilizers include polyalkylene glycol esters such as polyethylene glycol dibenzoate; polypropylene glycol dibenzoate; dipropylene glycol dibenzoate; diethylene/dipropylene glycol dibenzoate; polyethylene glycol dioleate; polyethylene glycol monolaurate; polyethylene glycol monooleate; triethylene glycol bis(2-ethylhexanoate; and triethylene glycol caprate-caprylate. Alkyl esters, substituted alkyl esters and aralkyl esters also act as compatibilizers including triethyl citrate; tri-n-butyl citrate, acetyltriethyl citrate; dibutyl phthalate; diethyl phthalate; dimethyl phthalate; dibutyl sebacate; dioctyl adipate; dioctyl phthalate; dioctyl terephthalate; tributoxyethyl phosphate; butylphthalylbutyl glycolate; dibutoxyethyl phthalate; 2-ethylhexyldiphenyl phthalate; and dibutoxyethoxyethyl adipate. Additional suitable compatibilizers include alkyl amides such as N,N-dimethyl oleamide and others including dibutoxyethoxyethyl formal; polyoxyethylene aryl ether; (2-butoxyethoxy) ethyl ester of mixed dibasic acids; and dialkyl diether glutarate. Compatibilizers are present in the final dry coating at levels of from about 4% to about 25% by weight of the total formulation, preferably from about 6% to about 20%.

Preferred compatibilizers are those having sufficiently low vapor pressures such that little or no evaporation occurs when heated during the fusing process. Such compatibilizers have boiling points of at least about 300° C., and preferred compatibilizers have boiling points of at least about 375° C.

One group of preferred compatibilizers comprises difunctional or trifunctional esters. As used herein, these esters, also called “di-esters” and “tri-esters”, refer to multiple esterification of a di-acid or tri-acid with an alcohol or the multiple esterification of a mono-acid with a diol or triol or a combination thereof. The governing factor is the presence of multiple ester linkages.

Useful compatibilizers in this group include such compatibilizers as dibutoxyethoxyethyl formal, dibutoxyethoxyethyl adipate, dibutyl phthalate, dibutoxyethyl phthalate, 2-ethylhexyl diphenyl phthalate, diethyl phthalate, dialkyl diether glutarate, 2-(2-butoxyethoxy)ethyl ester of mixed dibasic acids, triethyl citrate; tri-n-butyl citrate, acetyltriethyl citrate, dipropylene glycol dibenzoate, propylene glycol dibenzoate, diethylene/dipropylene dibenzoate, and the like.

The image receptive coating may also comprise additives in addition to the binders that can improve color quality, tack, and the like, in such amounts as do not effect the overall properties of the coated material. Useful additives include such as catalysts, thickeners, adhesion promoters, surfactants, glycols, defoamers, crosslinking agents, thickeners, and the like, so long as the addition does not negatively impact the surface resistivity of the receptor layer.

The coating can be applied to the film backing by any conventional coating technique, e.g., deposition from a solution or dispersion of the resins in a solvent or aqueous medium, or blend thereof, by means of such processes as Meyer bar coating, curtain coating, slide hopper coating, knife coating, reverse roll coating, rotogravure coating, extrusion coating, and the like, or combinations thereof.

Drying of the coating can be effected by conventional drying techniques, e.g., by heating in a hot air oven at a temperature appropriate for the specific film backing chosen. For example, a drying temperature of about 120° C. is suitable for a polyester film backing.

Preferred (dry) coating weights are from 0.5 g/m² to about 15 g/m², with 1 g/m² to about 10 g/m² being highly preferred. When the dry coating thickness is less than the lower limit, the surface resistivity is usually too high to provide quality toner powder images free from image distortion. Layers having a thickness greater than 15 g/m² tend to suffer cohesive failure with resulting offset of receptor material on to one or more parts, e.g. the fuser roll, of the electrophotographic printer or copier. The receptor layer thickness in this case satisfies practical requirements without contributing in a significant way to the control of surface resistivity.

To promote adhesion of the toner-receptive layer to the film backing, it may be desirable to treat the surface of the film backing with one or more primers, in single or multiple layers. Useful primers include those primers known to have a swelling effect on the film backing polymer. Examples include halogenated phenols dissolved in organic solvents. Alternatively, the surface of the film backing may be modified by treatment such as corona treatment or plasma treatment.

The backside of an image recording sheet according to the present invention may be coated with the same composition as a toner receptor layer. Application of the same toner receptor layer to both sides of an image recording sheet facilitates toner powder image formation on either one or both sides of the sheet regardless of sheet orientation, since both sides of the image recording sheet will have a surface resistivity in the desired range from about 10¹¹ Ω/square to about 10¹³ Ω/square. An alternate layer of a different composition may also be used to provide, for example, curl control and improved sheet feeding through electrophotographic imaging equipment.

Backside layers differing in composition from image receptor layers previously described may include a binder and a variety of additives. Suitable binders include thermoplastic resins such as polyester resins, styrene resins, acrylic resins, epoxy resins, styrene-butadiene copolymers, polyurethane resins, vinyl chloride resins, styrene-acrylic copolymers, and vinyl chloride-vinyl acetate resins.

The backside layer may be formed by mixing the above resin with an organic filler or an inorganic filler and optional additives and applying the mixture by the same conventional coating means described previously. Preferred (dry) coating weights are from 0.5 g/m² to about 15 g/m², with 1 g/m² to about 10 g/m² being highly preferred.

Suitable fillers for the backside layer include particulate organic resins, for example, fluororesins, such as ethylene tetrafluoride resin and ethylene/ethylene tetrafluoride copolymer, polyethylene resin, polystyrene resin, acrylic resin, polyamide resin, and benzguanamine resin. Inorganic fillers usable herein include silica colloidal silica, alumina, kaolin, clay, talc, titanium dioxide and calcium carbonate.)

The following examples are for illustrative purposes, and do not limit the scope of the invention, which is defined by the claims.

### Experimental

Test Methods

RESISITIVITY: A Keithley 6517A Electrometer/High Resistance Meter and Keithley 8009 Resistivity Test Fixture were used for measuring the resistivities of receptor layers according to the present invention after aging samples overnight, in an environmental chamber adjusted to 15° C. and 10-15% relative humidity (RH). An operating voltage of 500 volts was used for all samples. Readings were taken 60 seconds after the voltage was applied and were read to one decimal place. Typically 4-6 surface resistivity measurements were made for each sample to provide a relationship reflecting measured resistivity versus conducting polymer concentration corresponding to the coated formulations.

STATISTICAL REGRESSION OF RESISTIVITY DATA: The statistical analysis program Minitab (version 13.30) was used to evaluate the resistivity data. Because of e extremely large ranges of surface resistivity, all statistical analyses reflect the use of the base 10 logarithm of the resistivities.

The “Fitted Line Plot” option was used to create the best fit curves through the resistivity data. Because of the plateau shape of the resistivity curves, only the data between 10¹⁰ Ω/square and 10¹⁴ Ω/square was typically fit. This ensured the greatest accuracy in fitting the data in the resistivity range of interest.

The “Capability Analysis” option was used to demonstrate that the invention improves the ability to predict the mean resistivity as well as reducing the variation in the observed range of resistivities.

Key to Materials

Filler A—NALCO 2326 is a water based, 14% solids, 5 nm colloidal silica dispersion from Ondeo Nalco Co.

Filler B—NALCO 2327 is a water based, 40% solids, 20 nm colloidal silica dispersion from Ondeo Nalco Co.

Filler C—NALCO 2329 is a water based, 40% solids, 80 nm colloidal silica dispersion from Ondeo Nalco Co.

Filler D—JONCRYL 2189 is a 48.5% solids, styrene-acrylic latex available from Johnson Polymer.

### Filler E—250 nm PMMA is a 41.5% solids, poly(methyl methacrylate) latex having particle size of 250 nm, manufactured by 3M Co.

Conducting Polymer—BAYTRON P is a 1.3% polythiophene dispersion in water from Bayer, Corp.

Binder R—SANCURE 777 is a 35% polyurethane dispersion in water from Noveon, Inc.

Binder S—LUVISKOL K-17 is a aqueous 40% solids solution of poly(vinyl pyrrolidone) polymer from Bayer, Corp.

Surfactant P—DOW 193 is a silicone, 10% in water, available from Dow-Coming, Inc.

Surfactant Q—TRITON X-100 is a surfactant, 10% in water, available from Union Carbide, Inc.

Sample Preparation

All of the Examples according to the present invention and Comparative Examples were coated as the fluid compositions shown in Tables 1-7. The fluid compositions were adjusted to 14% solids before coating on 100 m primed polyethylene terephthalate (PET) film (manufactured by 3M Co.) having a coating weight of about 1.5 g/m². Coatings were applied using a #4 Mayer bar. The resulting coated films were oven-dried at 105° C. for 90 seconds.

Results

Tables 1-3 provide results of screening experiments to determine the combined effect of filler and conductive polymer on the surface resistivity of dried toner receptor layers applied to transparent film substrates. The tables show coating compositions as total composition, including water, with dry wt % of components being shown as a number in parenthesis.

Resistivity measurements for multiple intermediate samples prepared from each of high and low concentration sample pairs, recorded as Comparative Examples C1, C2; C3, C4; C5, C6 and Examples 1 and 2, Examples 3 and 4 and subsequent pairs through Examples 17 and 18, provided data that was submitted to statistical analysis using the computer program “Minitab.” This analysis produced best-fit curves identifying ranges of filler and conductive polymer most likely to provide coating compositions having controlled surface resistivities, when dry, in a range from about 10¹¹ Ω/square to about 10¹³ Ω/square. The resulting regression curves were obtained as Log Surface Resistivity vs conductive polymer concentration at each filler level. Three values of conductive polymer concentration were recorded, from the regression curves, corresponding to surface resistivity values of 10¹¹ Ω/square, 10¹² Ω/square and 10¹³ Ω/square.

Coating compositions of Examples 20-46 were derived using the three values of conductive polymer concentration identified by regression curve calculations previously discussed. The data appears as groups of three compositions. Each group has a common amount of filler and three different levels of conductive polymer corresponding to surface resistivities of 10¹¹ Ω/square, 10¹² Ω/square and 10¹³ Ω/square respectively. As discussed with reference to Table 5, surface resistivities for these compositions target the range predicted by regression analysis.

Table 4 includes coating compositions grouped as Comparative Examples for a variety of reasons. Examples C1 and C2 are similar to Examples 1-8 but contain no filler. The absence of filler causes inconsistency in the measured values of surface resistivity. This was further demonstrated by comparing results of Example 19, containing approximately 50% filler, with Example C7, which has a similar composition to Examples C1 and C2. Each of Examples 19 and C7 contain a concentration of conductive polymer predicted, by regression analysis, to be close to the mid-point of the concentration range that yields image recording sheets having surface resistivities in the range from about 10¹¹ Ω/square to about 10¹³ Ω/square. Samples were mixed to provide four replicates of each composition. Comparison of measured surface resistivity values to those predicted by regression analysis indicates that Example 19 gave more reliable results than Example C7. A study of process capability using Minitab provided a measure of reliability in terms of defects per million. Analysis of Example 9 suggested 9 failures per million trials, i.e. 9 defects per million. The corresponding value for Comparative Example C7 was 1.2×10⁵ per million, confirming superior performance for the composition containing 50% filler.

Comparative Examples C3 and C4 contain a polymethyl methacrylate filler having an average particle size of approximately 250 nm. This relatively large particle size material appears to interact with conductive polymer materials in the desired manner to provide improvement in control over surface resistivity. Dried toner powder receptor layers, however, fail because they are fragile and easily damaged. Also they have a hazy appearance unsuitable for use in image projection.

Comparative Examples C5 and C6 use a polyvinylpyrollidone binder to provide control of the surface resistivity of toner receptor layers. Though effective for this purpose these compositions require excessive concentrations of conductive polymer. Preferably the amount of conductive polymer is held to a minimum to reduce the cost of the preferred conductive polymer, BAYTRON P, which is a very expensive material.

TABLE 1
COMPOSITIONS HAVING CONTROLLED SURFACE RESISTIVITY EXAMPLES 1-8

| | EX. 1 | EX. 2 | EX. 3 | EX. 4 | EX. 5 | EX. 6 | EX. 7 | EX. 8 |
|---|---|---|---|---|---|---|---|---|
| | (dry wt %) | (dry wt %) | (dry wt %) | (dry wt %) | (dry wt %) | (dry wt %) | (dry wt %) | (dry wt %) |
| Water | 331.86 | 358.40 | 344.35 | 375.84 | 356.82 | 393.28 | 369.30 | 410.73 |
| | (0) | (0) | (0) | (0) | (0) | (0) | (0) | (0) |
| Filler B | 49.3 | 49.55 | 98.58 | 99.1 | 147.88 | 148.65 | 197.15 | 198.22 |
| | (19.72) | (19.82) | (39.43) | (39.64) | (59.15) | (59.46) | (78.86) | (79.29) |
| Conducting | 108.46 | 80.77 | 101.53 | 68.46 | 98.46 | 56.15 | 87.69 | 43.85 |
| Polymer | (1.41) | (1.05) | (1.32) | (0.89) | (1.28) | (0.73) | (1.14) | (0.57) |
| Binder R | 224.51 | 225.26 | 168.46 | 169.09 | 112.37 | 112.91 | 56.31 | 56.74 |
| | (78.58) | (78.84) | (58.96) | (59.18) | (39.33) | (39.52) | (19.71) | (19.86) |
| Surfactant P | 2.9 (0.29) | 2.9 (0.29) | 2.9 (0.29) | 2.9 (0.29) | 2.9 (0.29) | 2.9 (0.29) | 2.9 (0.29) | 2.9 (0.29) |

TABLE 2
COMPOSITIONS HAVING CONTROLLED SURFACE RESISTIVITY
EXAMPLES 9-14

| | EX. 9 | EX. 10 | EX. 11 | EX. 12 | EX. 13 | EX. 14 |
|---|---|---|---|---|---|---|
| | (dry wt %) | (dry wt %) | (dry wt %) | (dry wt %) | (dry wt %) | (dry wt %) |
| Water | 101.43 | 136.14 | 370.59 | 308.95 | 382.43 | 330.07 |
| | (0) | (0) | (0) | (0) | (0) | (0) |
| Filler A | 337.93 | 339.38 | | | | |
| | (49.0) | (49.21) | | | | |
| Filler B | | | 122.23 | 123.48 | | |
| | | | (48.89) | (49.39) | | |
| Filler C | | | | | 122.68 | 123.65 |
| | | | | | (49.07) | (49.46) |
| Conducting | 131.54 | 93.08 | 143.08 | 71.54 | 120.77 | 60.77 |
| Polymer | (1.71) | (1.21) | (1.86) | (0.93) | (1.57) | (0.79) |
| Binder R | 140.0 | 140.83 | 139.69 | 141.11 | 140.20 | 141.31 |
| | (49.0) | (49.29) | (48.89) | (49.39) | (49.07) | (49.46) |
| Surfactant P | 2.9 (0.29) | 2.9 (0.29) | 2.9 (0.29) | 2.9 (0.29) | 2.9 (0.29) | 2.9 (0.29) |

TABLE 1
COMPOSITIONS HAVING CONTROLLED
SURFACE RESISTIVITY EXAMPLES 15-19

| | EX. 15 | EX. 16 | EX. 17 | EX. 18 | EX. 19 |
|---|---|---|---|---|---|
| | (dry wt %) | (dry wt %) | (dry wt %) | (dry wt %) | (dry wt %) |
| Water | 327.39 | 395.96 | 238.66 | 348.43 | 366.61 |
| | (0) | (0) | (0) | (0) | (0) |
| Filler D | 100.80 | 101.83 | | | |
| | (48.89) | (49.39) | | | |
| Filler B | | | 120.75 | 122.60 | 123.30 |
| | | | (48.3) | (49.04) | (49.32) |
| Conducting | 143.08 | 71.54 | 185.38 | 70.77 | 82.31 |
| Polymer | (1.86) | (0.93) | (2.41) | (0.92) | (1.07) |
| Binder R | 139.69 | 141.11 | | | 140.91 |
| | (48.89) | (49.39) | | | (49.32) |
| Binder S | | | 161.0 | 163.47 | |
| | | | (48.3) | (49.04) | |
| Surfactant P | 2.9 (0.29) | 2.9 (0.29) | 2.8 (0.28) | 2.8 (0.28) | 2.9 (0.29) |
| Surfactant Q | | | 7.0 | 7.0 | |
| | | | (0.7) | (0.7) | |

TABLE 4
COMPARATIVE EXAMPLES C1-C7

| | EX. C1 | EX. C2 | EX. C3 | EX. C4 | EX. C5 | EX. C6 | EX. C7 |
|---|---|---|---|---|---|---|---|
| | (dry wt %) | (dry wt %) | (dry wt %) | (dry wt %) | (dry wt %) | (dry wt %) | (dry wt %) |
| Water | 340.95 | 319.39 | 356.92 | 404.49 | 0 | 600.14 | 323.47 |
| | (0) | (0) | (0) | (0) | | (0) | (0) |
| Filler B | 0 | 0 | | | 0 | 0 | 0 |
| Filler E | | | 118.57 | 119.45 | | | |
| | | | (49.21) | (49.57) | | | |
| Conducting | 93.08 | 115.38 | 93.08 | 43.85 | 1256.92 | 622.3 | 104.60 |
| Polymer | (1.21) | (1.50) | (1.21) | (0.57) | (16.34) | (8.09) | (1.36) |
| Binder R | 281.43 | 280.57 | 140.83 | 141.63 | | | 281.02 |
| | (98.5) | (98.2) | (49.29) | (49.57) | | | (98.36) |
| Binder S | | | | | 271.77 | 299.23 | |
| | | | | | (81.53) | (89.77) | |
| Surfactant P | 2.9 (0.29) | 2.9 (0.29) | 2.9 (0.29) | 2.9 (0.29) | 6.1 (0.61) | 2.9 (0.29) | 2.9 (0.29) |
| Surfactant Q | | | | | 15.3 | 15.3 | |
| | | | | | (1.53) | (1.53) | |

TABLE 5
COMPOSITIONS HAVING RESISTIVITY FROM
10¹¹-10¹³Ω/SQUARE EXAMPLES 20-31

| | EX. 20 | EX. 21 | EX. 22 | EX. 23 | EX. 24 | EX. 25 |
|---|---|---|---|---|---|---|
| | (dry wt %) | (dry wt %) | (dry wt %) | (dry wt %) | (dry wt %) | (dry wt %) |
| Filler B | 19.68 | 19.69 | 19.70 | 39.41 | 39.45 | 39.46 |
| Conducting Polymer | 1.30 | 1.24 | 1.21 | 1.19 | 1.09 | 1.05 |
| Binder R | 78.73 | 78.77 | 78.8 | 59.11 | 59.17 | 59.20 |
| Surfactant P | 0.29 | 0.29 | 0.29 | 0.29 | 0.29 | 0.29 |
| Surface Resistivity Ω/square | 10¹¹ | 10¹² | 10¹³ | 10¹¹ | 10¹² | 10¹³ |
| EX. 26 | EX. 27 | EX. 28 | EX. 29 | EX. 30 | EX. 31 | |
| (dry wt %) | (dry wt %) | (dry wt %) | (dry wt %) | (dry wt %) | (dry wt %) | |
| Filler B | 59.14 | 59.26 | 59.27 | 79.03 | 79.01 | 79.11 |
| Conducting Polymer | 1.04 | 0.94 | 0.92 | 0.92 | 0.85 | 0.82 |
| Binder R | 39.43 | 39.51 | 39.52 | 19.76 | 19.77 | 19.78 |
| Surfactant P | 0.29 | 0.29 | 0.29 | 0.29 | 0.29 | 0.29 |
| Surface Resistivity Ω/square | 10¹¹ | 10¹² | 10¹³ | 10¹¹ | 10¹² | 10¹³ |

Table 5 shows compositions corresponding to toner powder image recording sheets having surface resistivities controlled at 10¹¹ Ω/square, 10¹² Ω/square and 10¹³ Ω/square. There is a noticeable variation in the range of conductive polymer with increasing amounts of filler. The filler in this case is a colloidal silica (NALCO 2327) having an average particle size of 20 μm. Treatment of this powder by the conductive polymer (BAYTRON P) provides powdered antistats according to the present invention. Changes in the amount of conductive polymer, for controlled surface resistivity, indicate the occurrence of an interaction between the filler and conductive polymer. For example, as the amount of filler increases from about 20% to about 80% of an image receptor layer there is a clear reduction in the amount of conductive polymer required to provide image recording sheets with surface resistivities in the desired range of about 10¹¹ Ω/square to about 10¹³ Ω/square. As the amount of conductive polymer decreases there is an increase in the weight range of conductive polymer that will produce powdered antistats corresponding to the preferred range of surface resistivities. Expansion of the range of conductive polymer allows consistent preparation of coating compositions that, after drying, provide receptor layers containing powdered antistats that impart reproducible surface resistivity to image recording sheets according to the present invention. This will be further reinforced during discussion of Table 6 below.

Table 6 provides information similar to Table 5 concerning the increase in formulation range of conducting polymer. In this case the expansion of range may be attributed to a change in filler particle size. Examples 32-34 use colloidal silica filler (NALCO 2326) having an average particle size of 5 nm; Examples 35-37 use colloidal silica filler (NALCO 2327) having an average particle size of 20 nm and Examples 38-40 use colloidal silica (NALCO 2329) having an average particle size of 80 nm. The formulating range for NALCO 2326 is clearly broader than the corresponding ranges for NALCO 2327 and 2329. Examples 41-43 show that non-silica fillers interact with conductive fillers, e.g. BAYTRON P, to provide dry powdered antistats suitable for image recording sheets meeting surface resistivity requirements of the present invention. Examples 44-46 show that other binders can be used with similar effect.

Table 7 includes Comparative Examples C8-C16 representing three groups of similar compositions designed to fall within a surface resistivity range of from 10¹¹ Ω/square to 10¹³ Ω/square. Comparative Examples C8-C10 contain no filler and deviate frequently from the desired range of surface resistivity. While giving consistent values of surface resistivity at reduced levels of conducting polymer, the filler used in Comparative Examples C11-C13 causes unacceptable embrittlement and haziness of dried coatings. Comparative Examples C14-C16 also provide surface resistivity control but require excessive amounts of conducting polymer, which adds to the cost of image recording sheets according to the present invention.

Table 8 includes the compositions of toner powder receptor layers that provide image recording sheets having a surface resistivity of about 10¹² Ω/square. Information of formulation tolerance indicates the allowable error for the amount of conducting polymer included in the composition without deviating from required values of surface resistivity in the range from 10¹¹ Ω/square to 10¹³ Ω/square. A relationship between surface resistivity and BAYTRON P concentration provided a formulation tolerance or mischarge tolerance to assess the stability of surface resistivities to fluctuations in BAYTRON P concentration. Formulation Tolerance or Mischarge Tolerance may be used interchangeably herein to represent the percent allowable error in BAYTRON P concentration without departure from the desired surface resistivity range of about 10¹¹ Ω/square to about 10¹³ Ω/square. Derivation of a numerical value for Formulation Tolerance requires division of one-half the width of the BAYTRON P concentration range between 10¹¹ and 10¹³ Ω/square by the average concentration (the midpoint) in the concentration range of the compositions in each group of three. The resulting value expressed as a percentage of the range is the formulation tolerance, which indicates how much (+/−) the BAYTRON P concentration can vary before the resistivity goes either below about 10¹¹ Ω/square or above about 10¹³ Ω/square.

The results of formulation tolerance provide an explanation for earlier failure to consistently meet a desired surface resistivity using a combination of resin and conducting polymer alone. Example C9 shows that, in the absence of filler, control of surface resistivity requires the amount of conducting polymer to remain within 2.4% of the quantity needed for a surface resistivity of 10¹² Ω/square. If formulation errors exceed 2.4% the resulting surface resistivity will be either below 10¹¹ Ω/square or above 10¹³ Ω/square.

The behavior of the conducting polymer changes in the presence of fillers, suggesting an interaction between these materials to provide improved formulation tolerance and control of surface resistivity. Addition of increasing amounts of the same filler (Examples 21, 24, 27 and 30) shows expansion of the range of formulating error while providing toner receptor layers having surface resistivities in the required range. Samples 33, 36, 39 and 42 provide results showing that variation of filler or filler particle size also improves formulation tolerance. Results based upon colloidal silica show that, for materials tested, the filler material of smallest particle size (NALCO 2326) allowed the greatest margin for errors of formulation.

TABLE 6
COMPOSITIONS HAVING RESISTIVITY FROM
10¹¹-10¹³Ω/SQUARE EXAMPLES 32-46

| | EX. 32 | EX. 33 | EX. 34 | EX. 35 | EX. 36 | EX. 37 | EX. 38 | EX. 39 | EX. 40 |
|---|---|---|---|---|---|---|---|---|---|
| | (dry wt %) | (dry wt %) | (dry wt %) | (dry wt %) | (dry wt %) | (dry wt %) | (dry wt %) | (dry wt %) | (dry wt %) |
| Filler A | 49.02 | 49.15 | 49.20 | | | | | | |
| Filler B | | | | 49.31 | 49.35 | 49.36 | | | |
| Filler C | | | | | | | 49.36 | 49.41 | 49.43 |
| Conducting Polymer | 1.67 | 1.41 | 1.32 | 1.10 | 1.02 | 0.99 | 0.99 | 0.90 | 0.86 |
| Binder R | 49.02 | 49.15 | 94.20 | 49.31 | 49.35 | 49.36 | 49.36 | 49.41 | 49.43 |
| Surfactant P | 0.29 | 0.29 | 0.29 | 0.29 | 0.29 | 0.29 | 0.29 | 0.29 | 0.29 |
| Surface | 10¹¹ | 10¹² | 10¹³ | 10¹¹ | 10¹² | 10¹³ | 10¹¹ | 10¹² | 10¹³ |
| Resistivity Ω/square | | | | | | | | | |
| EX. 41 | EX. 42 | EX.43 | EX. 44 | EX. 45 | EX. 46 | | | | |
| (dry wt %) | (dry wt %) | (dry wt %) | (dry wt %) | (dry wt %) | (dry wt %) | | | | |
| Filler D | 49.13 | 49.18 | 49.19 | | | | | | |
| Filler B | | | | 48.22 | 48.65 | 48.80 | | | |
| Conducting Polymer | 1.45 | 1.36 | 1.33 | 2.58 | 1.71 | 1.42 | | | |
| Binder R | 49.13 | 49.18 | 49.19 | | | | | | |
| Binder S | | | | 48.22 | 48.65 | 48.80 | | | |
| Surfactant P | 0.29 | 0.29 | 0.29 | 0.28 | 0.28 | 0.28 | | | |
| Surfactant Q | | | | 0.70 | 0.70 | 0.70 | | | |
| Surface | 10¹¹ | 10¹² | 10¹³ | 10¹¹ | 10¹² | 10¹³ | | | |
| Resistivity Ω/square | | | | | | | | | |

TABLE 7
COMPOSITIONS HAVING RESISTIVITY FROM
10¹¹-10¹³Ω/SQUARE COMPARATIVE EXAMPLES C8-C16

| | EX. C8 | EX. C9 | EX. C10 | EX. C11 | EX. C12 | EX. C13 | EX. C14 | EX. C15 | EX. C16 |
|---|---|---|---|---|---|---|---|---|---|
| | (dry wt %) | (dry wt %) | (dry wt %) | (dry wt %) | (dry wt %) | (dry wt %) | (dry wt %) | (dry wt %) | (dry wt %) |
| Filler B | 0 | 0 | 0 | | | | 0 | 0 | 0 |
| Filler E | | | | 49.40 | 49.46 | 49.47 | | | |
| Conducting Polymer | 1.43 | 1.39 | 1.36 | 0.91 | 0.80 | 0.77 | 12.66 | 10.39 | 9.13 |
| Binder R | 98.28 | 98.32 | 98.35 | 49.4 | 49.46 | 49.47 | | | |
| Binder S | | | | | | | 85.20 | 87.47 | 88.73 |
| Surfactant P | 0.29 | 0.29 | 0.29 | 0.29 | 0.29 | 0.29 | 0.61 | 0.61 | 0.61 |
| Surfactant Q | | | | | | | 1.53 | 1.53 | 1.53 |
| Surface | 10¹¹ | 10¹² | 10¹³ | 10¹¹ | 10¹² | 10¹³ | 10¹¹ | 10¹² | 10¹³ |
| Resistivity Ω/square | | | | | | | | | |

TABLE 8
FORMULATION TOLERANCE

| | Filler | | Formulation | |
|---|---|---|---|---|
| | (Identity) | Binder | Tolerance % | Comment |
| Example 21 | 20 (B) | 80 | 3.7 | Clear Sheet |
| Example 24 | 40 (B) | 60 | 6.6 | Clear Sheet |
| Example 27 | 60 (B) | 40 | 6.1 | Clear Sheet |
| Example 30 | 80 (B) | 20 | 5.5 | Clear Sheet |
| Example 33 | 50 (A) | 50 | 11.8 | Clear Sheet |
| Example 36 | 50 (B) | 50 | 5.2 | Clear Sheet |
| Example 39 | 50 (C) | 50 | 7.1 | Slight haze |
| Example 42 | 50 (D) | 50 | 4.1 | Clear Sheet |
| Example 45 | 50 (B) | 50 | 28.8 | Clear Sheet |
| Example C9 | 0 | 100 | 2.4 | Inconsistent |
| Example C12 | 50 (E) | 50 | 8.3 | Easily damaged |
| | | | | Hazy |
| Example C15 | 0 | 100 | 16.2 | Excessive |
| | | | | amount of |
| | | | | Conducting |
| | | | | Polymer |

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

What is claimed is:

1. An image recording sheet comprising:
a substrate having a first surface opposite a second surface,
a toner receptor layer coated on at least said first surface, said toner receptor layer including:
a binder having a concentration from about 19 dry wt % to about 80 dry wt % of said toner receptor layer;
a conductive polymer; and
a filler having a concentration from about 19 dry wt % to about 80 dry wt %, said filler interacting with said conductive polymer to provide an antistat imparting to said toner receptor layer a surface resistivity in a range from 10¹¹ ohms/square to 10¹³ ohms/square

2. The image recording sheet of claim 1, wherein said binder is selected from the group consisting of polyester resins, styrene resins, acrylic resins, epoxy resins, styrene-butadiene copolymers, polyurethane resins, vinyl chloride resins, styrene-acrylic copolymers, and vinyl chloride-vinyl acetate resins.

3. The image recording sheet of claim 1, wherein said conductive polymer is selected from the group consisting of polyanilines and polythiophenes.

4. The image recording sheet of claim 3, wherein said conductive polymer is BAYTRON P.

5. The image recording sheet of claim 1, wherein said conductive polymer has a concentration from about 0.5 dry wt % to about 3.0 dry wt % of said toner receptor layer

6. The image recording sheet of claim 1, wherein said filler has an average particle size from about 5 nm to about 100 nm.

7. The image recording sheet of claim 1, wherein said filler is colloidal silica having an average particle size from about 5 nm to about 80 nm.

8. The image recording sheet of claim 1, wherein said concentration of said filler is from about 40 dry wt % to about 60 dry wt %.

9. A toner powder receptor comprising:
a binder having a concentration from about 19 dry wt % to about 80 dry wt % of said composition;
a conductive polymer; and
a filler having a concentration from about 19 dry wt % to about 80 dry wt %, said filler interacting with said conductive polymer to provide an antistat imparting to said toner receptor a surface resistivity in a range from 10¹¹ ohms/square to 10¹³ ohms/square

10. The toner powder receptor of claim 9, wherein said binder is selected from the group consisting of polyester resins, styrene resins, acrylic resins, epoxy resins, styrene-butadiene copolymers, polyurethane resins, vinyl chloride resins, styrene-acrylic copolymers, and vinyl chloride-vinyl acetate resins.

11. The toner powder receptor of claim 9, wherein said conductive polymer is selected from the group consisting of polyanilines and polythiophenes.

12. The toner powder receptor of claim 9, wherein said conductive polymer is BAYTRON P.

13. The toner powder receptor of claim 9, wherein said conductive polymer has a concentration from about 0.5 dry wt % to about 3.0 dry wt % of said toner receptor layer

14. The toner powder receptor of claim 9, wherein said filler has an average particle size from about 5 nm to about 100 nm.

15. The toner powder receptor of claim 9, wherein said filler is colloidal silica having an average particle size from about 5 nm to about 80 nm.

16. An antistat comprising the product of interaction of an electronically conducting polymer with a filler having a particle size from about 5 nm (0.005 μm) to about 100 nm (0.1 μm).

17. The antistat of claim 16, wherein said conductive polymer is selected from the group consisting of polyanilines and polythiophenes.

18. The antistat of claim 16, wherein said filler is colloidal silica.
